(19) United States
(12) Patent Application Publication
(10) Pub. No.: US 2012/0083321 A1
(43) Pub. Date: Apr. 5, 2012

(54) Secondary Picking Device for a Hops Picking Machine, and Hops Picking Machine Equipped Therewith

(75) Inventors: Elisabeth Fuß, Pfeffenhausen (DE); Josef Fuß, Pfeffenhausen (DE)

(73) Assignee: Fuß Fahrzeug-und Maschinenbau GmbH & Co., KG, Schkolen (DE)

(21) Appl. No.: 13/249,898

(22) Filed: Sep. 30, 2011

(30) Foreign Application Priority Data
Oct. 1, 2010 (DE) 10 2010 037 929.8

(51) Int. Cl. A01D 46/02

(52) U.S. Cl. 460/126

(57) ABSTRACT

A secondary picking device for a hops picking machine comprises a cone picking device and a tine strip device which interact in such a way that the sections thereof facing each other are moved in a same direction while defining between them a picking range through which the vine parts are passed in order to pick hop cones. The picking range has a curved shape, and at least one combing cylinder is present which is arranged downstream from the picking range in the direction of movement of the vine parts. At least one combing cylinder interacts with the cone picking device and rotates opposite to the direction of movement of the associated section of the cone picking device in order to strip off vine parts.

The invention relates to a secondary picking device for a hops picking machine, comprising a cone picking device and a tine strip device which interact in such a way that the sections thereof facing each other are moved in a same direction while defining between them a picking range through which vine parts are passed in order to pick hop cones. The invention moreover relates to a hops picking machine in accordance with the preamble of claim 9 or 10.

Hops picking machines provided with such secondary picking devices are being widely used. Hops picking machines are typically subdivided into four essential basic units which are, however, not necessarily joined together in a compact, integrated unit. On the input side, the vines are as a general rule supplied in a suspended state to a main picking device having the form, for example, of a belt-type picking device where any vine parts laterally projecting from the vine stalk are then stripped or torn off. Depending on the random application of forces to the vine parts in the main picking device, a certain proportion of single cones and a considerable proportion of vine parts which include cones but are still connected to small branches, leaves and cones are already picked there in clusters. The picked cones drop downwards through the constituent parts of the main picking device onto a conveyor belt and are carried off for further processing.

Vine parts still present are frequently supplied to a further belt-type picking device or the like that may equally be subsumed under the main picking device and where the picking operation is repeated, in order to separate out further cones and move them off via a conveyor means.

Vine parts still present finally arrive from the main picking device in the intake area of a secondary picking device which has the function of stripping or plucking off, i.e. separating out, further cones from the larger vine parts still containing cones. The cones thus harvested then arrive at a cleaning device such as, e.g., an aspirator, while the remaining vine parts are guided to a roller cleaner. In a global view, it is thus possible to obtain a nearly complete separation of cones that are subsequently subjected to a drying step.

One example of a like hops picking machine became known from DE 10 2006 044 920 A1. In this case a belt-type picking device is employed as a secondary picking device which comprises an endless transporting device circulating in the manner of a conveyor belt in order to feed vines or vine parts previously separated from the vine stalk, and a circulating picking device having a multiplicity of movably retained picking fingers which moves in the opposite sense of the transporting device while being operated at a higher moving velocity than the transporting device. Here the picking device also has an endless circulating configuration in the manner of a conveyor belt, with straight sections of the picking device and of the transporting device being disposed adjacent and substantially in parallel with each other so as to form an elongate, planar picking range for the vine parts passed between them.

This type of a secondary picking device for a hops picking machine has found very good acceptance in practical use. Nevertheless it was found that despite improvements of the picking result, hop cones may still be present in a certain degree on the vine stalks that are carried off.

The invention is therefore based on the object of further developing a secondary picking device for a hops picking machine in such a way as to achieve a further improved picking result. In addition it is intended to provide a corresponding hops picking machine.

This object is achieved through a secondary picking device having the features of claim 1 for a hops picking machine. It is in particular characterized by the fact that the picking range has a curved shape, and in that furthermore at least one combing cylinder is present which is arranged downstream from the picking range in the direction of movement of the vine parts, wherein the at least one combing cylinder interacts with the cone picking device and rotates opposite to the direction of movement of the associated section of the cone picking device in order to strip off vine parts.

In accordance with the invention it was surprisingly found that the picking result may be improved if the vine parts passed through the secondary picking device are moved in an arc shape in the picking range. As a result, areas of the vine parts which might not be reached if passed through rectilinearly are subjected to the picking operation. It is thus possible to reliably pick even hop cones having a comparatively concealed position.

It is another advantage of the secondary picking device of the invention that owing to the curved shape of the picking range, there exists a relatively large engagement area for this processing step without the overall assembly having to be given excessively large dimensions.

Apart from this it was found that the curved shape of the picking range causes the vine parts at the exit from the curved picking range to be erected in a certain degree, which allows effective access to these in a further picking step by means of a combing cylinder. In accordance with the invention, the latter rotates opposite to the direction of movement of the supplied vine parts which are substantially entrained with the cone picking device on account of the curved shape of the picking range. This brings about more effective stripping of these vine parts and of hop cones possibly still present on them. Hereby the picking result may be improved further.

In addition, this stripping function of the combing cylinder also reliably prevents vine parts from being entrained by the cone picking device, which might otherwise result in material being backed up. Hereby the capacity of the secondary picking device of the invention is improved substantially. In particular, maintenance processes and above all cleaning processes during ongoing operation are required only at prolonged time intervals.

Advantageous developments of the secondary picking device of the invention are subject matter of appended claims 2 to 8.

Thus, the cone picking device may comprise a plurality of picking fingers retained in a springily movable manner, the ends of which essentially have the form of triangularly projecting portions, with these ends extending substantially against the direction of movement of the cone picking device. Here it was found in practical experimentation that particularly gentle and also effective harvesting of the hop cones may be obtained in this case. The picking fingers brush over the vine parts carried along by the tine strip device, with their ends trapping hop cones that might still be present. This trapping step does not take place in an isolated location at the tip of a triangular picking finger as in the prior art but substantially across the entire width thereof, for the end portions of the picking fingers provided on them are angled against the direction of movement of the cone picking device and therefore approximately in a tangential direction. Due to the triangular shape, hop cones that might still be present are finally guided into the tip of the triangle and retained there, which results in particularly gentle picking of the hop cones. Hereby it is possible to once again clearly improve the picking result with regard to both quantity and integrity of the harvested hop cones.

The cone picking device may have the form of a picking cylinder. Such a configuration may be provided at low technological complexity. The operation of such a cylinder-type cone picking device moreover involves particularly low complexity as cylinders, in contrast with conveyor belts, merely require a rotating axle.

Alternatively it is also possible for the cone picking device to be realized in the form of a picking belt extending substantially vertically to the picking range. In this case the deflection area of the picking belt faces the picking range to thus automatically result in the curved shape of the latter. This realization presents the advantage that such a picking belt may be kept clear, at lower complexity, of branches etc. possibly trapped therein, and clogging of the assembly may thus also be precluded more reliably than in the case of a picking cylinder.

An additional advantage exists if the tine strip device comprises a plurality of tine strips which are formed with notches. Practical experimentation in this regard showed that the picking result may even be improved further hereby as the processed vine portions are caught more reliably on these notches than in the prior art, to thus be subjected to a more intense plucking action. In particular this allows to separate hops clusters more reliably.

The tine strip device may moreover be constituted by two adjacent tine strip cylinders which may rotate in a same sense of rotation relative to each other. This design is characterized by its low technological and financial expenditure for both provision and operation. In particular, cylinders may be operated with less complexity than belts, for instance. In addition the picking range having a curved shape in accordance with the invention results automatically in this case on account of the interaction of the two adjacent tine strip cylinders with the adjacent cone picking device, with the latter interacting with the tine strip cylinders in the area in which these three elements have a tangential relative arrangement. Supplied vine parts are received by the first tine strip cylinder and plucked by the cone picking device while being pushed into the curved picking range; subsequently the vine parts are received by the second tine strip cylinder, in turn transported against the cone picking device interacting with the latter, and plucked again. The vine parts correspondingly pass through a substantially curved trajectory defined, in accordance with the invention, as the picking range. Hereby an even further improved picking result is achieved.

Alternatively it is also possible for the tine strip device to be constituted by a tine strip belt which is configured in an arc shape in the area of the picking range. This also allows to obtain a particularly long picking range in cooperation with the curvature of the adjacent cone picking device, whereby an improved picking result may be achieved.

It is furthermore advantageous if the at least one combing cylinder is realized with notches, which thus also serves to obtain particularly good action on the vine portions. In particular it is thus possible to obtain even more reliable cleaning of the cone picking device due to correspondingly good stripping of vine parts. The cleaning intervals for the cone picking device may hereby be prolonged even further, so that the operation of the secondary picking device becomes even more economical.

According to another aspect of the present invention according to claim 9, a hops picking machine comprising a main picking device and a secondary picking device is furnished. It is characterized particularly by the fact that a secondary picking device of the invention is utilized, and that the tine strip device is constituted by a tine strip belt of the main picking device which protrudes into the range of the secondary picking device and is configured in an arc shape in the picking range.

As a result it is possible in accordance with the invention to omit a separate device for the tine strip belt of the secondary picking device, whereby the construction of the hops picking machine is simplified further. Moreover it is then possible in a particularly reliable manner to transport vine parts from the main picking device directly into the secondary picking device. Apart from this, the advantages discussed in the foregoing in the context of the secondary picking device are obtained likewise.

According to a further aspect of the present invention according to claim 10, a hops picking machine comprising a main picking device and a secondary picking device is provided which is characterized by the fact that a secondary picking device of the invention is employed, and in that the cone picking device thereof interacts with a picking element of the main picking device in such a way that these move tangentially against each other in order to strip off vine parts.

Hereby it is achieved that the cone picking device at the same time carries out a kind of cleaning step on the picking element of the main picking device, whereby a material backup on the main picking device may be avoided even more reliably. Corresponding manual cleaning steps thus need to be performed less often than in the prior art, whereby the economy of the operation of the assembly is enhanced. In addition, hop cones which may still be present on vine parts carried along with the picking element of the main picking device may in this case also be stripped off by the cone picking device, to thereby perform an additional picking step. This brings about a particularly good picking result.

In the following the invention shall be explained in more detail through practical examples while making reference to the drawings, wherein:

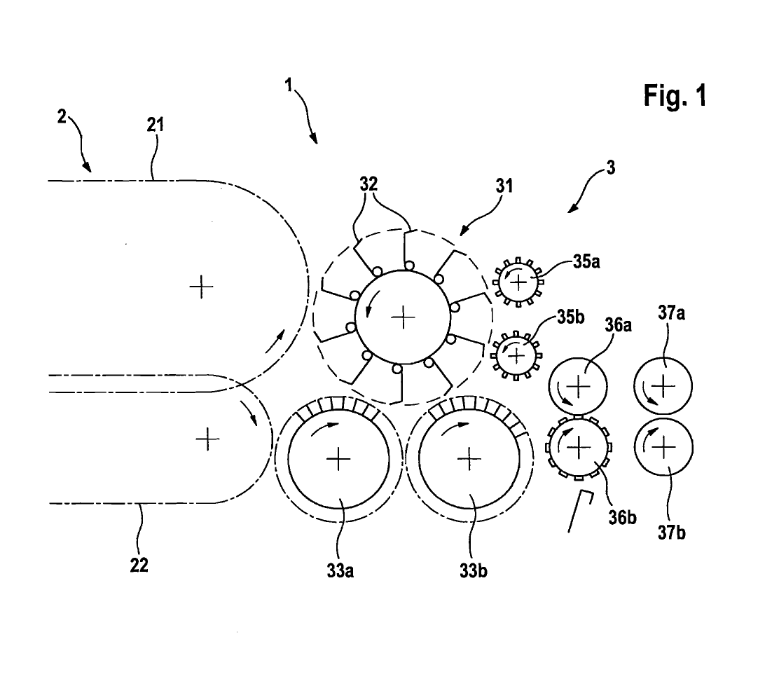

FIG. 1 is a schematic lateral view of a portion of a hops picking machine of the invention;

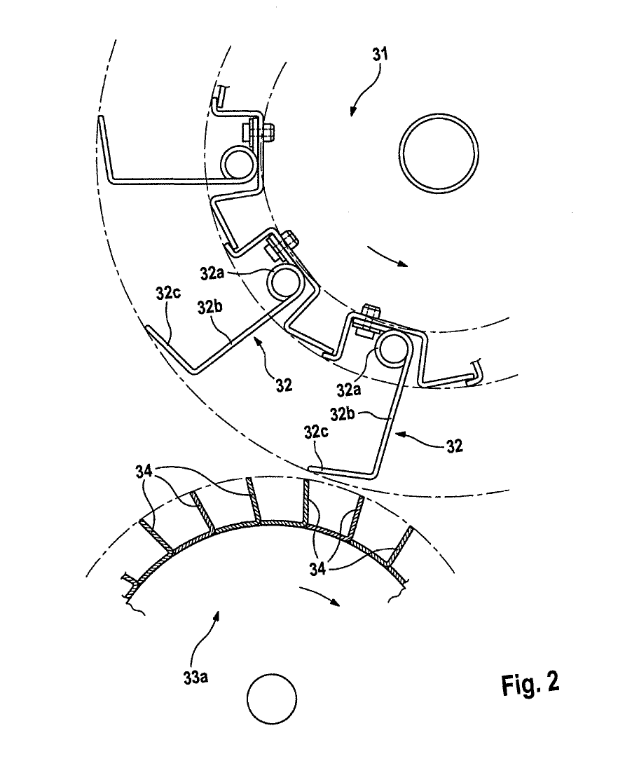

FIG. 2 is a detail view in the picking range of the hops picking machine of the invention;

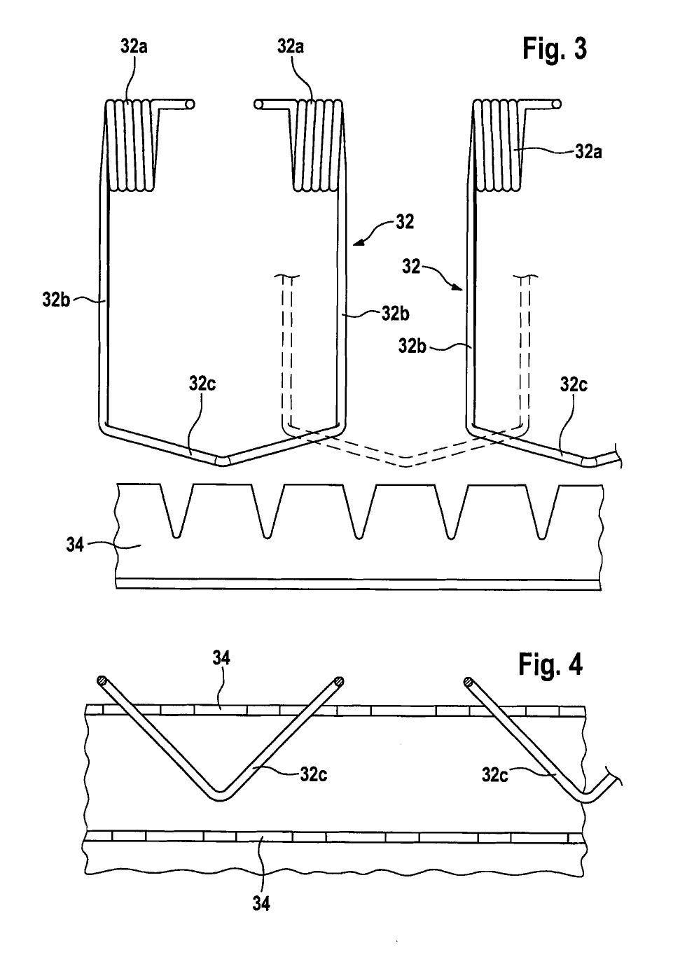

FIG. 3 is a front view in the picking range;

FIG. 4 is a top view of the representation in FIG. 3;

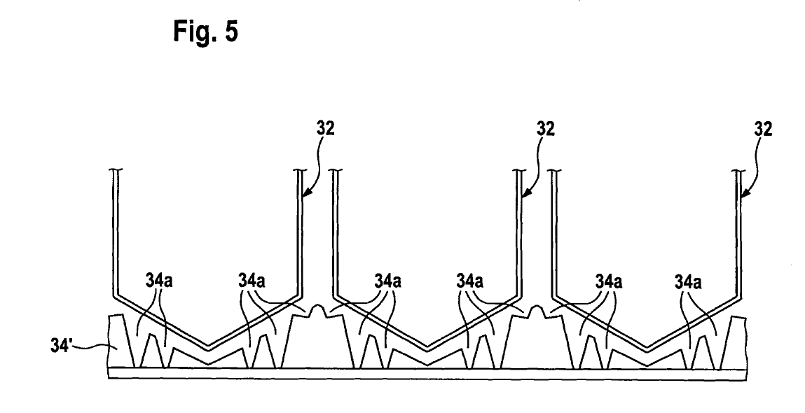

FIG. 5 shows a modified embodiment of a tine strip; and

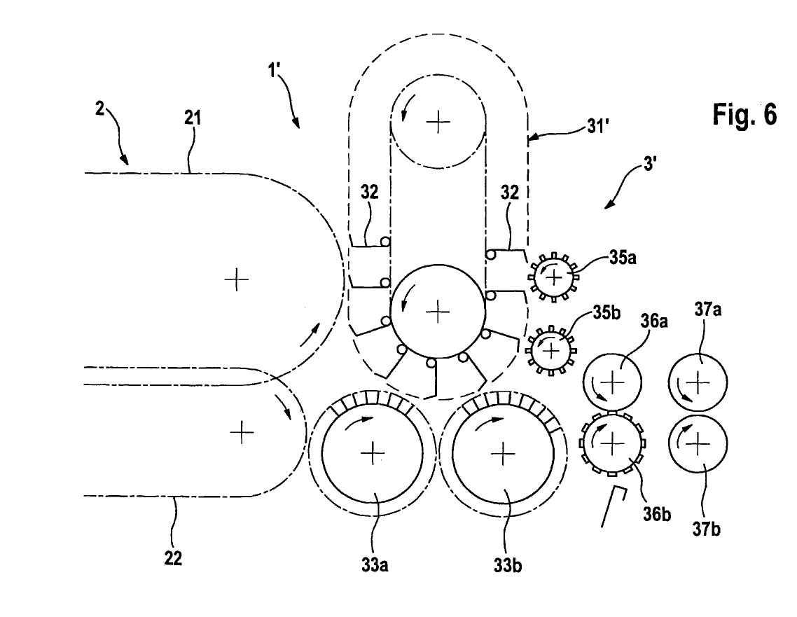

FIG. 6 is a schematic lateral view of a portion of a hops picking machine of the invention in accordance with another embodiment.

In accordance with the representation in FIG. 1, a hops picking machine 1 comprises a main picking device 2 and a secondary picking device 3.

The main picking device 2 is represented schematically in partial areas thereof only. It comprises a picking element 21 as well as a tine strip belt 22 and has a conventional configuration, as it were. In the present practical example, the realization of the main picking device 2 substantially corresponds to that of the belt-type picking device of DE 10 2006 044 920 A1 which is employed there as a secondary picking device. Concerning further details in this regard, reference is made to the contents of that document.

The secondary picking device 3 comprises a cone picking device 31 which is realized in the form of a picking cylinder in the present practical example. The cone picking device 31 supports on its circumference a plurality of picking fingers 32 which shall be explained in more detail later on.

The secondary picking device 3 further comprises two tine strip cylinders 33a and 33b which are arranged, in accordance with the representation of FIG. 1, adjacent each other while only leaving a slight gap between each other. These two tine strip cylinders 33a and 33b jointly constitute a tine strip device defining, in cooperation with the cone picking device 31, a picking range having a curved shape. The curvature of the picking range is essentially determined by the radius of the cone picking device 31 and by the outer orbit of the picking fingers 32, respectively. The tine strip cylinders 33a and 33b support on their circumference respective pluralities of tine strips 34 which shall equally be explained in more detail later on.

Apart from this, the secondary picking device 3 in the present practical example comprises two combing cylinders 35a and 35b which interact with the cone picking device 31. The combing cylinders 35a and 35b support strip-type projections on their circumference, as is directly evident from FIG. 1 in particular.

The secondary picking device 3 further comprises a first pair of extraction cylinders 36a and 36b as well as a second pair of extraction cylinders 37a and 37b. These extraction cylinder pairs are arranged downstream from the other constituent parts of the secondary picking device 3 when viewed in the transporting direction of the vine parts.

The individual constituent parts of the main picking device 2 or of the secondary picking device 3, respectively, are designed to be movable, with the corresponding arrows in FIG. 1 indicating the direction of rotation or circulation of the respective constituent part. Accordingly, the tine strip belt 22, the tine strip cylinders 33a and 33b and the extraction cylinders 36b and 37b move clockwise, whereas the picking element 21, the cone picking device 31, the combing cylinders 35a and 35b, as well as the extraction cylinders 36a and 37a move counter-clockwise.

FIG. 2 shows a detail of FIG. 1 illustrating more closely the interaction of the cone picking device 31 with the tine strip cylinder 33a. FIG. 3 shows a front view of the situation of FIG. 2, while FIG. 4 represents a top view of FIG. 3.

As may be seen from FIGS. 2 to 4, the picking fingers 32 are realized as a wire construction and are retained on the cylinder of the cone picking device 31 in a springily movable manner. They each include two spring portions 32a, in the area of which they are attached to the cylinder body of the cone picking device 31. In addition the picking fingers 32 include two finger portions 32b radially extending away from the cylinder of the cone picking device 31. These finger portions 32b continue into an end 32c of the picking fingers 32. The finger portions 32b are two spaced-apart wires which are connected to each other in the area of the end 32c. The picking fingers 32 thus are an open wire construction where hop cones may be trapped.

As may be seen in FIGS. 2 to 4, the end 32c of a picking finger 32 is bent approximately at a right angle from the finger portions 32b, with this angle being approx. 80 degrees in the present example. The end 32c extends against the direction of movement of the cone picking device 31 when the latter is moved in normal operation, and approximately in a tangential direction. Due to the angled shape of the end 32c relative to the finger portion 32b, a picking finger 32 is capable of trapping hop cones across its entire width.

As is evident from FIG. 2 in particular, the cone picking device 31 and the associated tine strip cylinder 33a have a relative arrangement such that the picking fingers 32 and the tine strips 34 just about fail to contact each other with a slight gap between them. Due to the directions of movement of the cone picking device 31 and of the tine strip cylinder 33a, vine parts supplied by the main picking device 2 are drawn into the small interstice between the tine strip cylinder 33a and the cone picking device 31 and subjected to processing.

In practical operation, the cone picking device 31 rotates at a substantially higher rotational speed than the associated tine strip cylinder 33a. As a result, the picking fingers 32 brush over the vine parts held by the tine strips 34 and pluck off hop cones. In a practical example the cone picking device 31 rotates, for instance, at a rotational speed of 100 rpm. The tine strip cylinder 33a rotates at a speed of approx. 8 rpm. In practical operation the second tine strip cylinder 33b is generally moved about 25% faster than the first tine strip cylinder 33a, i.e., it rotates at a speed of approx. 10 rpm.

This difference in rotational speed of the two tine strip cylinders 33a and 33b has the result that vine parts entrained on them are tensed in the range of action of the cone picking device 31. This results in a particularly favorable picking result.

The constellation among the cone picking device 31 and the second tine strip cylinder 33b substantially corresponds to the one shown in FIG. 2 by the example of the first tine strip cylinder 33a. In the area where the two tine strip cylinders 33a and 33b and the cone picking device 31 are adjacent each other a picking range is thus created which, based on the radius of the cone picking device 31, has a shape curved substantially along the arc of a circle.

In this regard it may moreover be seen from FIG. 4 that the tines of two adjacent tine strips 34 are arranged at an offset. In a corresponding manner the picking fingers 32 on the cone picking device 31, which are essentially arranged side by side in rows, have an arrangement which is offset from one row to the next one. This is illustrated in FIG. 3 by the picking finger of the next row of picking fingers which is indicated in dashed lines.

The picking result is moreover improved if the tine strips have the form of tine strips 34′ and present notches 34a as are shown in FIG. 5. Vine parts may get caught on them, whereby it is possible to detach the hop cones from them even more reliably.

In the following the operation of the hops picking machine 1 is explained in more detail.

At the outset, vine parts having already been partly plucked are introduced from the main picking device 2 into the secondary picking device 3. There they enter into the taking-in range of the first tine strip cylinder 33a, are grasped by the latter, and taken into the picking range between the two tine strip cylinders 33a and 33b and the cone picking device 31. As was already explained in the foregoing, the particular arrangement of the constituent parts of the secondary picking device 3 results in a curved picking range in which hop cones that may still be present are stripped from the vine parts. They may then drop down onto a conveyor belt (not shown) and be carried off for further processing.

When the vine parts exit from the picking range, they project toward the combing cylinders 35a and 35b due to the curved shape of the picking range, or are entrained in this direction by the cone picking device 31. The combing cylinders 35a and 35b rotate in the opposite sense of the cone picking device 31 and cause the vine parts to be combed from it. This prevents the hop vines or vine parts from being wound around the cone picking device 31.

The vine parts are then supplied to the two extraction cylinder pairs or introduced there, respectively. These two pairs 36a and 36b and 37a and 37b rotate in respective opposite directions so that the vine parts present are forcibly drawn in between them. This prevents them from dropping onto a collecting belt (not shown) for the hop cones that is present underneath, which would bring about an additional requirement to clean the latter. The vine parts pulled off by the respective extraction cylinder pairs 36a and 36b and 37a and 37b are then supplied, e.g., to a roller cleaner in a manner that is customary per se.

In order to improve the transporting effect, one of the extraction cylinders—such as the extraction cylinder 36b in the present example and/or any other one of the extraction cylinders—may present a profile on the circumferential face. The upper extraction cylinders 36a and 37a are moreover adapted to be arranged at an offset, so that a gap between the latter and the associated lower extraction cylinder 36b and 37b is variable as a function of a supplied quantity of vine parts. Clogging of the assembly is hereby prevented.

FIG. 6 shows another embodiment of a hops picking machine 1′ where a secondary picking device 3′ is realized differently from the embodiment according to FIG. 1.

The difference resides in the configuration of the cone picking device 31′ which in this case is realized as a picking belt. As is represented in FIG. 6, the cone picking device 31′ is positioned substantially vertically above the picking range formed jointly with the tine strip cylinders 33a and 33b. This results likewise in the creation of a curved processing or picking range in the deflection portion of the cone picking device 31′.

As for the further constituent parts, this further embodiment corresponds to the realization in accordance with FIG. 1, for which reason the corresponding reference symbols were used for the constituent parts thereof and a closer explanation thereof is omitted accordingly. As for the functional interaction of the constituent parts, there is no substantial difference from the embodiment in accordance with FIG. 1.

Both embodiments finally have in common that the cone picking device 31 or 31′ interacts with the picking element 21 of the main picking device 2 and strips off vine parts possibly entrained there by their opposite-sense movement, to take them to the picking range.

Besides the discussed embodiments, the invention admits further design approaches.

Thus it is not necessary to provide two combing cylinders 35a and 35b; instead it is also possible to utilize only a single combing cylinder. Particularly in the case of the embodiment in accordance with FIG. 6 it is also possible to use several combing cylinders.

The circumferential projections on the combing cylinders 35a and 35b may also be constituted by simple strips, or also by tine strips. Moreover it is also possible to provide these strips with notches similar to the notches of the tine strip cylinder, to thus allow for a more reliable transport of vine parts.

The cone picking device 31 or 31′ may also be realized with picking elements other than the illustrated picking fingers. Instead of the specialized picking fingers having angled ends 32c as used in accordance with the invention, it is in particular also possible to utilize picking fingers which are per se conventional and have ends which are not bent or are bent only at a slight angle relative to the finger portion.

The shape of the tine strip 34 may furthermore vary from the one in FIGS. 3 and 5. In the most simple case it is already sufficient to employ straight strips devoid of tines or notches.

Instead of the two tine strip cylinders 33a and 33b it is furthermore also possible to employ a tine strip belt which is configured in an arc shape in the picking range.

In addition it is also possible to design the tine strip belt 22 of the main picking device 2 with a greater length than in FIGS. 1 and 6 and take it as far as into the range of the cone picking device 31. The latter may then serve the function of the tine strip cylinders, with the correspondingly modified tine strip belt then being configured in an arc shape in the picking range.

The rotational speeds of the cone picking device 31 or 31′ and of the two tine strip cylinders 33a and 33b must be harmonized appropriately. In practical experimentation it was found to be favorable if the cone picking device 31 or 31′ is operated at approximately ten times the speed of the second tine strip cylinder 33b which, in turn, runs about 25% faster than the first tine strip cylinder 33a. These speed relations may, however, be selected differently depending on the sort of hops to be processed as well as other parameters.

The extraction cylinders 36a and 36b or 37a and 37b may also be omitted.

In some applications it may moreover be sensible to provide a parting curtain, a partition wall, etc. on the side of the combing cylinders 35a and 35b facing away from the cone picking device 31 or 31′. Hop cones that may have been severed here can thus be prevented more reliably from inadvertently entering the range of the extraction cylinders, leaving the harvesting circuit, and being lost.

1. A secondary picking device for a hops picking machine, comprising a cone picking device and a tine strip device which interact in such a way that sections thereof facing each other are moved in a same direction while defining between them a picking range through which vine parts are passed in order to pick hop cones,
wherein:
the picking range has a curved shape, and
moreover at least one combing cylinder is present which is arranged downstream from the picking range in a direction of movement of the vine parts, wherein the at least one combing cylinder interacts with the cone picking device and rotates opposite to a direction of movement of an associated section of the cone picking device in order to strip off vine parts.

2. The secondary picking device according to claim 1, wherein the cone picking device comprises a plurality of picking fingers retained in a springily movable manner, ends of which essentially have a form of triangularly projecting portions, with the ends extending substantially against a direction of movement of the cone picking device.

3. The secondary picking device according to claim 1, wherein the cone picking device is realized in a form of a picking cylinder.

4. The secondary picking device according to claim 1, wherein the cone picking device is realized in a form of a picking belt extending substantially vertically to the picking range.

5. The secondary picking device according to claim 1, wherein the tine strip device comprises a plurality of tine strips which are formed with notches.

6. The secondary picking device according to claim 1, wherein the tine strip device is constituted by two adjacent tine strip cylinders which rotate in a same sense of rotation relative to each other.

7. The secondary picking device according to claim 1, wherein the tine strip device is constituted by a tine strip belt which is configured in an arc shape in an area of the picking range.

8. The secondary picking device according to claim 1, wherein the at least one combing cylinder is realized with notches.

9. A hops picking machine comprising a main picking device and a secondary picking device, the secondary picking device comprising a cone picking device and a tine strip device which interact in such a way that sections thereof facing each other are moved in a same direction while defining between them a picking range through which vine parts are passed in order to pick hop cones, wherein the picking range has a curved shape, and moreover at least one combing cylinder is present which is arranged downstream from the picking range in a direction of movement of the vine parts, wherein the at least one combing cylinder interacts with the cone picking device and rotates opposite to a direction of movement of an associated section of the cone picking device in order to strip off vine parts wherein the tine strip device is realized by a tine strip belt of the main picking device which protrudes into the range of the secondary picking device and is configured in an arc shape in the picking range.

10. A hops picking machine comprising a main picking device and a secondary picking device, the secondary picking device comprising a cone picking device and a tine strip device which interact in such a way that sections thereof facing each other are moved in a same direction while defining between them a picking range through which vine parts are passed in order to pick hop cones, wherein the picking range has a curved shape, and moreover at least one combing cylinder is present which is arranged downstream from the picking range in a direction of movement of the vine parts, wherein the at least one combing cylinder interacts with the cone picking device and rotates opposite to a direction of movement of an associated section of the cone picking device in order to strip off vine parts wherein the cone picking device thereof interacts with a picking element of the main picking device in such a way that these move tangentially against each other in order to strip off vine parts.
